(19) United States
(12) Patent Application Publication
(10) Pub. No.: US 2019/0182509 A1
(43) Pub. Date: Jun. 13, 2019

(54) METHOD OF CORRECTING IMAGE DATA AND DISPLAY APPARATUS FOR PERFORMING THE SAME

(71) Applicant: SAMSUNG DISPLAY CO., LTD., YONGIN-SI (KR)

(72) Inventors: YOONGU KIM, Seoul (KR); Sukjin Park, Daejeon (KR); Kwan-Young Oh, Hanam-si (KR); Wonhee Lee, Bucheon-si (KR); Sangsu Han, Hanam-si (KR)

(21) Appl. No.: 16/216,061

(22) Filed: Dec. 11, 2018

(30) Foreign Application Priority Data
Dec. 13, 2017 (KR) 10-2017-0171091

(51) Int. Cl. H04N 19/80; H04N 19/176; H04N 19/12; G09G 5/02

(52) U.S. Cl. CPC H04N 19/80; G09G 5/02; H04N 19/12; H04N 19/176

(57) ABSTRACT

A display apparatus includes a first compensation part that corrects image data using an LUT that stores correction data corresponding to the image data, where grayscale differences between low-grayscale correction data and low-grayscale image data are greater than grayscale differences between middle-grayscale correction data and middle-grayscale image data, and a low-grayscale filter that transforms grayscale values of low-grayscale image data into predetermined low-grayscale values when grayscale values of the low-grayscale image data are less than or equal to a threshold low-grayscale value.

### PRIORITY STATEMENT

This application claims priority under 35 U.S.C. § 119 from, and the benefit of, Korean Patent Application No. 10-2017-0171091, filed on Dec. 13, 2017 in the Korean Intellectual Property Office, the contents of which are herein incorporated by reference in their entirety.

### BACKGROUND

### 1. Technical Field

Exemplary embodiments of the inventive concept are directed to a display apparatus and a method of driving the display apparatus. More particularly, exemplary embodiments of the inventive concept are directed to a display apparatus that can improve display quality and a method of driving the display apparatus.

### 2. Discussion of the Related Art

A display apparatus, such as a liquid crystal display (“LCD”) apparatus or an organic light emitting diode (“OLED”) display apparatus, typically includes a display panel and a display panel driver. The display panel includes a plurality of gate lines, a plurality of data lines and a plurality of pixels connected to the gate lines and the data lines. The display panel driver includes a gate driver that provides gate signals to the gate lines and a data driver that provides data voltages to the data lines.

To increase display quality of an LCD apparatus, an adaptive color correction dynamic (“ACC”) method is used with the LCD apparatus. In addition, to increase response speed of the LCD apparatus, a dynamic capacitance compensation (“DCC”) method can be used with the LCD apparatus.

In a DCC method, grayscales of present frame image data are compensated based on previous frame image data and the present frame image data. To operate a DCC method, an LCD apparatus further includes a memory to store the previous frame image data, which can increase the size of the LCD apparatus and a manufacturing cost of the LCD apparatus.

Image compression methods can be used to reduce the size of the image data so that the data can be efficiently transmitted and stored. For example, unnecessary or redundant portions may be reduced or omitted to reduce the image data size.

### SUMMARY

Exemplary embodiments of the inventive concept can provide a method of correcting image data that improves display quality of a low-grayscale image.

Exemplary embodiments of the inventive concept can also provide a display apparatus that performs the method of correcting image data.

According to an exemplary embodiment, a method of correcting image data includes correcting image data using a look-up table (LUT) that stores correction data, where grayscale differences between low-grayscale correction data and low-grayscale image data are greater than grayscale differences between middle-grayscale correction data and middle-grayscale image data, transforming grayscale values of low-grayscale image data into predetermined low-grayscale values when grayscale values of the low-grayscale image data are less than or equal to a threshold low-grayscale value, and correcting low-grayscale image data of a current frame using predetermined low-grayscale values of a previous frame.

In an exemplary embodiment, the method may further include correcting low-grayscale image data of the current frame using the LUT, compressing and decompressing low-grayscale image data of the previous frame, correcting decompressed low-grayscale image data of the previous frame using the LUT, and transforming grayscale values of low-grayscale correction data of the previous frame into the predetermined low-grayscale values when grayscale values of the low-grayscale correction data are less than or equal to the threshold low-grayscale value.

In an exemplary embodiment, the method may further include correcting low-grayscale image data of the current frame using the LUT, compressing and decompressing low-grayscale image data of the previous frame, transforming grayscale values of decompressed low-grayscale data of the previous frame into the predetermined low-grayscale values when grayscale values of the decompressed low-grayscale data are less than or equal to the threshold low-grayscale value, and correcting the predetermined low-grayscale data of the previous frame using the LUT.

In an exemplary embodiment, the method may further include correcting low-grayscale image data of the current frame using the LUT, transforming grayscale values of low-grayscale image data of the previous frame into predetermined low-grayscale values when grayscale values of the low-grayscale image data of the previous are less than or equal to the threshold low-grayscale value, compressing and decompressing the predetermined low-grayscale values of the previous frame, and correcting the decompressed predetermined low-grayscale data of the previous frame using the LUT.

In an exemplary embodiment, the predetermined low-grayscale values may be less than or equal to the threshold low-grayscale value.

According to all exemplary embodiment of the inventive concept, there is provided a display apparatus. The display apparatus includes a compression processor that compresses image data using a memory, a first compensation part that corrects image data using a look-up table (LUT) that stores correction data, where grayscale differences between low-grayscale correction data and low-grayscale data are greater than grayscale differences between middle-grayscale correction data and middle-grayscale data, a low-grayscale filter that transforms grayscale values of low-grayscale image data into predetermined low-grayscale values when grayscale values of the low-grayscale image data are less than or equal to a threshold low-grayscale value, and a second compensation part that corrects low-grayscale image data of a current frame using predetermined low-grayscale values of a previous frame.

In an exemplary embodiment, the first compensation part may include a first compensator that corrects image data of the current frame using the LUT, and a second compensator that corrects image data of the previous frame using the LUT.

In an exemplary embodiment, the compression processor may compress and decompress low-grayscale image data of the previous frame, the second compensator may correct decompressed low-grayscale image data of the previous frame using the LUT, and the low-grayscale filter may transforms grayscale values of the low-grayscale correction data of the previous frame into predetermined low-grayscale values when the grayscale values of the low-grayscale correction data are less than or equal to the threshold low-grayscale value.

In an exemplary embodiment, the compression processor may compress and decompress low-grayscale image data of the previous frame, the low-grayscale filter may transforms grayscale values of decompressed low-grayscale image data of the previous frame into predetermined low-grayscale values When grayscale values of the decompressed low-grayscale image data are less than or equal to the threshold low-grayscale value, and the second compensator may corrects the predetermined low-grayscale value of the previous frame using the LUT.

In an exemplary embodiment, the low-grayscale filter may transforms grayscale values of low-grayscale image data of the previous frame into predetermined low-grayscale values when grayscale values of the low-grayscale image data of the previous are less than or equal to the threshold low-grayscale value, the compression processor may compress and decompresses the predetermined low-grayscale values of the previous frame, and the second compensator may corrects decompressed predetermined low-grayscale values of the previous frame using the LUT.

In an exemplary embodiment, the predetermined low-grayscale values may be less than or equal to the threshold low-grayscale value.

In an exemplary embodiment, the display apparatus may further include a display panel that includes a plurality of pixels that are connected to a plurality of data lines and a plurality of gate lines; a data driver that generates data voltages using correction data received from the second compensation part and provides the data voltage to the plurality of data lines, and a gate driver that provides a plurality of gate signals to the plurality of gate lines.

According to an exemplary embodiment of the inventive concept, there is provided a display apparatus. The display apparatus includes a first compensation part that corrects image data using a look-up table (LUT) that stores correction data, where the first compensation part includes a first compensator that corrects data of a current frame using the LUT and a second compensator that corrects data of a previous frame using the LUT, where a grayscale differences between low-grayscale correction data and low-grayscale image data are greater than grayscale differences between middle-grayscale correction data and middle-grayscale image data, a low-grayscale filter that transforms grayscale values of low-grayscale image data into predetermined low-grayscale values when grayscale values of the low-grayscale image data are less than or equal to a threshold low-grayscale value, and a second compensation part that corrects low-grayscale image data of the current frame using predetermined low-grayscale values of the previous frame.

In an exemplary embodiment, the display apparatus may further include a compression processor that compresses and decompresses low-grayscale data of the previous frame. The second compensator may correct decompressed low-grayscale data of the previous frame using the LUT, and the low-grayscale filter may transform grayscale values of the low-grayscale correction data of the previous frame into predetermined low-grayscale values when the grayscale values of the low-grayscale correction data are less than or equal to the threshold low-grayscale value.

In an exemplary embodiment, the display apparatus may further include a compression processor that compresses and decompresses low-grayscale data of the previous frame. The low-grayscale filter may transform grayscale values of decompressed low-grayscale data of the previous frame into predetermined low-grayscale values when grayscale values of the decompressed low-grayscale data are less than or equal to the threshold low-grayscale value, and the second compensator may correct the predetermined low grayscale values of the previous frame using the LUT.

In an exemplary embodiment, the display apparatus may further include a compression processor that compresses and decompresses image data using a memory. The low-grayscale filter may transform grayscale values of low-grayscale data of the previous frame into a predetermined low-grayscale value when grayscale values of the low-grayscale data of the previous are less than or equal to the threshold low-grayscale value, the compression processor may compress and decompress predetermined low-grayscale values of the previous frame, and the second compensator may correct decompressed predetermined low-grayscale values of the previous frame using the LUT.

In an exemplary embodiment, the predetermined low-grayscale values may be less than or equal to the threshold low-grayscale value.

In an exemplary embodiment, the display apparatus may further include a display panel that includes a plurality of pixels that are connected to a plurality of data lines and a plurality of gate lines, a data driver that generates data voltages using correction data received from the second compensation part and provides the data voltages to the plurality of data lines, and a gate driver that provides a plurality of gate signals to the plurality of gate lines.

According to embodiments of the inventive concept, grayscale data changed by compression and decompression processes can be transformed into predetermined low-grayscale data. Therefore, low-grayscale image display defects, such as flicker or other artifacts, etc., can be decreased.

### BRIEF DESCRIPTION OF THE DRAWINGS

FIG. 1 is a block diagram of a display apparatus according to an exemplary embodiment.

FIG. 2 is a block diagram of a timing controller of FIG. 1, according to an exemplary embodiment.

FIG. 3 is a graph of grayscale differences between input image data and correction data for an ACC method according to an exemplary embodiment.

FIGS. 4A and 4B are graphs that illustrate DCC method according to an exemplary embodiment.

FIG. 5 is a block diagram of a correction data generator of FIG. 2, according to an exemplary embodiment.

FIG. 6 is a block diagram of a correction data generator according to a comparative exemplary embodiment.

FIG. 7A is a table that illustrates a LUT for an ACC method according to an exemplary embodiment.

FIG. 7B is a table that illustrates a LUT for a DCC method according to an exemplary embodiment.

FIG. 7C is a table that illustrates a method of generating correction data according to an exemplary embodiment and a comparative exemplary embodiment.

FIG. 8 is a block diagram of a timing controller according to an exemplary embodiment.

FIG. 9 is a block diagram of a timing controller according to an exemplary embodiment.

### DETAILED DESCRIPTION OF EXEMPLARY EMBODIMENTS

Hereinafter, the inventive concept will be described in detail with reference to the accompanying drawings.

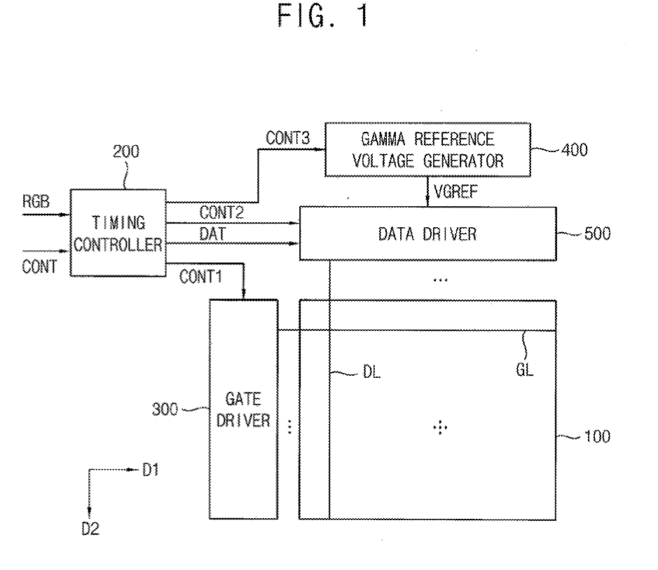

FIG. 1 is a block diagram of a display apparatus according to an exemplary embodiment.

Referring to FIG. 1, according to an exemplary embodiment, a display apparatus includes a display panel 100 and a driving part. The driving part includes a timing controller 200, a gate driver 300, a gamma reference voltage generator 400 and a data driver 500.

According to an exemplary embodiment, the display panel 100 has a display region on which an image is displayed and a peripheral region adjacent to the display region.

According to an exemplary embodiment, the display panel 100 includes a plurality of gate lines GL, a plurality of data lines DL and a plurality of pixels electrically connected to the gate lines GL and the data lines DL. The gate lines GL extend in a first direction D1 and the data lines DL extend in a second direction D2 that crosses the first direction D1.

According to an exemplary embodiment, each pixel includes a switching element, a liquid crystal capacitor and a storage capacitor. The liquid crystal capacitor and the storage capacitor are electrically connected to the switching element. The pixels are disposed in a matrix form.

According to an exemplary embodiment, the timing controller 200 receives input image data RGB and an input control signal CONT from an external apparatus. Herein, the terms input image data RGB and input image signal have substantially the same meaning. The input image data RGB includes red image data R, green image data G and blue image data B. The input control signal CONT may include a master clock signal and a data enable signal. The input control signal CONT further includes a vertical synchronizing signal and a horizontal synchronizing signal.

According to an exemplary embodiment, the timing controller 200 generates a first control signal CONT1, a second control signal CONT2, a third control signal CONT3 and a data signal DAT based on the input image data RGB and the input control signal CONT

According to an exemplary embodiment, the timing controller 200 generates the first control signal CONT1 to control operation of the gate driver 300 based on the input control signal CONT, and outputs the first control signal CONT1 to the gate driver 300. The first control signal CONT1 further includes a vertical start signal and a gate clock signal.

According to an exemplary embodiment, the timing controller 200 generates the second control signal CONT2 to control operation of the data driver 500 based on the input control signal CONT, and outputs the second control signal CONT2 to the data driver 500. The second control signal CONT2 includes a horizontal start signal and a load signal.

According to an exemplary embodiment, the timing controller 200 generates the data signal DAT based on the input image data RGB. The timing controller 200 outputs the data signal DAT to the data driver 500. The data signal DAT is substantially the same as the input image data RGB. Alternatively, the data signal DAT may be compensated image data generated by compensating the input image data RGB. In one exemplary embodiment, for example, the timing controller 200 generates the data signal DAT by selectively performing at least one of display quality compensation, stain compensation, adaptive color correction (“ACC”) or dynamic capacitance compensation (“DCC”).

According to an exemplary embodiment, the timing controller 200 generates the third control signal CONT3 to control operation of the gamma reference voltage generator 400 based on the input control signal CONT, and outputs the third control signal CONT3 to the gamma reference voltage generator 400.

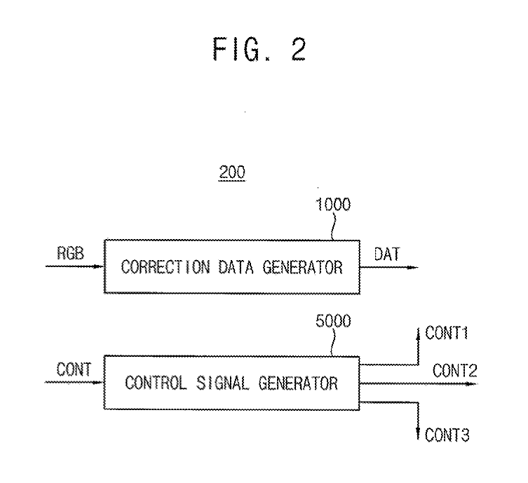

The structure and the operation of the timing controller 200 will be described below in greater detail with reference to FIG. 2.

According to an exemplary embodiment, the gate driver 300 generates gate signals to drive the gate lines GL in response to the first control signal CONT1 received from the timing controller 200. The gate driver 300 sequentially outputs the gate signals to the gate lines GL.

The gate driver 300 may be disposed, e.g., directly mounted, on the display panel 100, or may be connected to the display panel 100 as a tape carrier package (“TCP”). Alternatively, the gate driver 300 may be integrated into the display panel 100.

According to an exemplary embodiment, the gamma reference voltage generator 400 generates a gamma reference voltage VGREF in response to the third control signal CONT3 received from the timing controller 200. The gamma reference voltage generator 400 outputs the gamma reference voltage VGREF to the data driver 500. The gamma reference voltage VGREF has a value that corresponds to a level of the data signal DAT.

In an alternative exemplary embodiment, the gamma reference voltage generator 400 may be disposed in the timing controller 200 or in the data driver 500.

According to an exemplary embodiment, the data driver 500 receives the second control signal CONT2 and the correction data DAT from the timing controller 200, and receives the gamma reference voltages VGREF from the gamma reference voltage generator 400. The data driver 500 converts the correction data DAT into analog data voltages using the gamma reference voltages VGREF. The data driver 500 outputs the data voltages to the data lines DL.

The data driver 500 may be disposed, e.g., directly mounted, on the display panel 100, or be connected to the display panel 100 in a TCP. Alternatively, the data driver 500 may be integrated into the display panel 100.

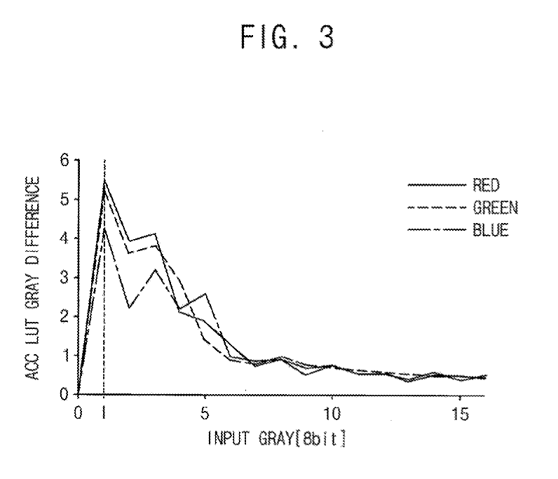

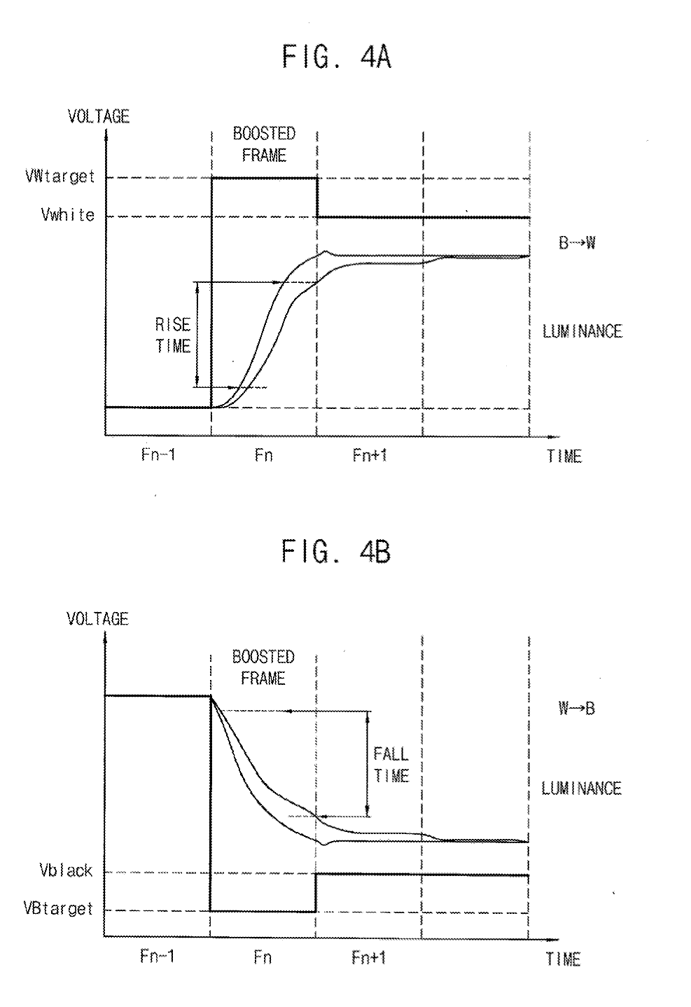

FIG. 2 is a block diagram that illustrates a timing controller of FIG. 1 according to an exemplary embodiment. FIG. 3 is a graph of grayscale differences between input image data and correction data for an ACC method. FIGS. 4A and 4B are graphs that illustrate a DCC method.

Referring to FIGS. 1 and 2, according to an exemplary embodiment, the timing controller 200 includes a correction data generator 1000 and a control signal generator 5000.

According to an exemplary embodiment, the data signal generator 1000 generates the data signal DAT based on the input image data RGB. The data signal generator 1000 outputs the data signal DAT to the data driver 500. The data signal generator 1000 may compensate the input image data RGB to generate the data signal DAT.

In one exemplary embodiment, for example, the data signal generator 1000 generates the data signal DAT by selectively performing at least one of display quality compensation, stain compensation, ACC or DCC.

According to an exemplary embodiment, ACC is a method of compensating a grayscale value of the input image data to reducing or removing a color coordinate shift due to a grayscale change of the input image data such that color balance is maintained despite the grayscale change of the input image data.

According to an exemplary embodiment, ACC uses red, green and blue look-up tables (LUTs) which respectively store red, green and blue correction data for separately transforming red, green and blue gamma curves. For example, ACC may generate red correction data that corresponds to red input image data using a red LUT.

Referring to FIG. 3, according to an exemplary embodiment, differences between grayscale values of correction image data generated by ACC and the input image data are greater in a low-grayscale region than in a middle-grayscale region. For example, when red, green and blue input image data greyscale values are all ‘1’, respectively, red, green and blue correction image data generated from ACC have grayscale differences of about ‘4’ to about ‘6’ with respect to the grayscale values of red, green and blue input image data. As shown in FIG. 1, grayscale differences between the input image data and the correction image data are large in a low-grayscale region in which grayscale values are less than or equal to ‘10’.

According to an exemplary embodiment, DCC is a method for compensating grayscale values of input image data to improve response times of the liquid crystal due to a grayscale change.

Referring to FIG. 4A, according to an exemplary embodiment, when input image data corresponds to pixels that change from black-grayscale data in an (n−1)-th frame Fn-1 to white-grayscale data in an n-th frame Fn, DCC compensates the white-grayscale data in the n-th frame Fn to generate white-correction data that corresponds to a white target voltage VWtarget whose luminance is greater than the luminance of a white voltage Vwhite that corresponds to the white-grayscale data. Therefore, when input image data changes from black-grayscale data to white-grayscale data, a response time of the liquid crystal is improved.

However, referring to FIG. 4B, according to an exemplary embodiment, when input image data corresponds to pixels that change from white-grayscale data in an (n−1)-th frame Fn-1 to black-grayscale data in the n-th frame Fn, DCC compensates the black-grayscale data in the n-th frame Fn to generate black-correction data that corresponds to a black target voltage VBtarget whose luminance is less than the luminance of a black voltage Vblack that corresponds to the black-grayscale data. Therefore, when input image data changes from white-grayscale data to black-grayscale data, a response time of the liquid crystal is improved.

As described above, according to an exemplary embodiment, DCC includes a memory which stores image data of a previous frame co that image data of a current frame can be compared with image data of the previous frame. To reduce memory size and cost, the image data of a frame can be compressed and decompressed.

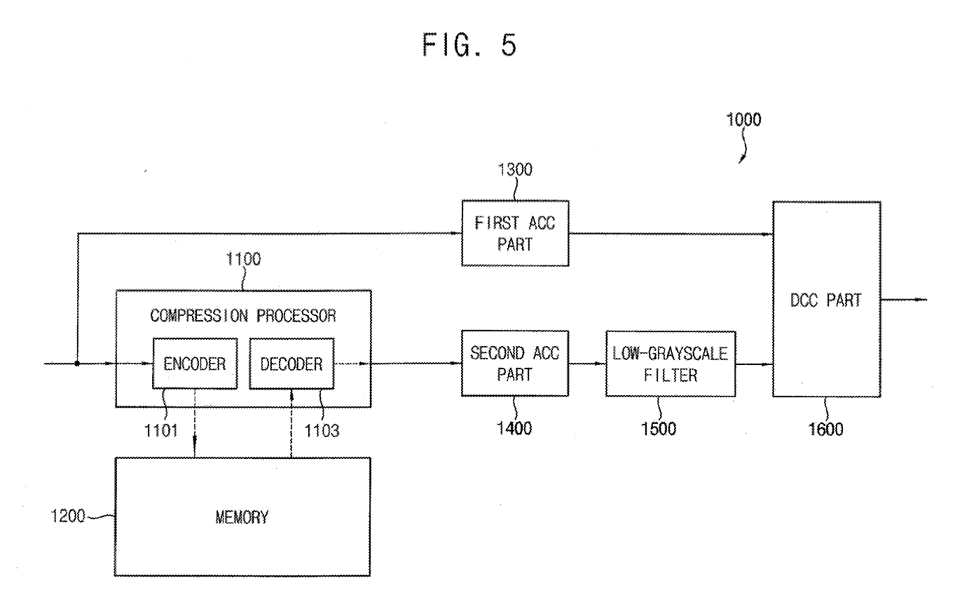

The structure and the operation of the correction data generator 1000 according to an exemplary embodiment will be described below in greater detail with reference to FIG. 5.

According to an exemplary embodiment, the control signal generator 5000 generates the first control signal CONT1, the second control signal CONT2 and the third control signal CONT3 based on the input control signal CONT. The control signal generator 5000 outputs the first control signal CONT1 to the gate driver 300. The control signal generator 5000 outputs the second control signal CONT2 to the data driver 500. The control signal generator 5000 outputs the third control signal CONT3 to the gamma reference voltage generator 400.

FIG. 5 is a block diagram of a correction data generator of FIG. 2 according to an exemplary embodiment.

Referring to FIG. 5, according to an exemplary embodiment, the correction data generator 1000 includes a compression processor 1100, a memory 1200, a first ACC part 1300, a second ACC part 1400, a low-grayscale filter 1500 and a DCC part 1600.

According to an exemplary embodiment, the compression processor 1100 includes an encoder 1101 and a decoder 1103. The encoder 1101 compresses frame image data using a predetermined compression process that has a predetermined compressibility and stores the compressed image data in the memory 1200. Increasing the compressibility reduces a size of the memory 120 needed for storage. The decoder 1103 decompresses the compressed image data using the memory 1200.

According to an exemplary embodiment, the first ACC part 1300 receives current frame image data and generates correction image data for the current frame using ACC and a LUT. The first ACC part 1300 includes red, green and blue LUTs that respectively correspond to red, green and blue image data.

According to an exemplary embodiment, the second ACC part 1400 receives decompressed previous frame image data from the decoder 1103 and generates previous frame correction image data using ACC and another LUT. The second ACC part 1400 includes red, green and blue LUTs that respectively correspond to red, green and blue image data.

According to an exemplary embodiment, when correction image data grayscale values are less than or equal to a threshold low-grayscale value, the low-grayscale filter 1500 generates predetermined low-grayscale value from the previous frame correction image data grayscale values received from the second ACC part 1400. The predetermined low-grayscale values are less than or equal to the threshold low-grayscale values.

For example, according to an exemplary embodiment, the compression processor 1100 compresses pixel image data based on its relationship with neighboring pixel image data. Thus, when image data of the neighboring pixels changes, the compressed image data is decompressed to different image data despite being image data of a same pixel. As described above, as the decompressed pixel image data changes over time, grayscale differences between input image data and ACC correction image data increase in the low-grayscale region. For example, when the decompressed pixel image data change between a 1-grayscale and a 2-grayscale, the ACC correction image data has grayscale differences that are greater than 4 grayscales with respect to the restored image data, which is the input image data shown in FIG. 3. Therefore, display defects such as a flicker or other artifacts, etc., can occur in the low-grayscale region.

According to an exemplary embodiment, the low-grayscale filter 1500 consistently transforms grayscale values that are less than or equal to a threshold low-grayscale value into a predetermined low-grayscale value. Therefore, low-grayscale image display defects, such as a flicker and other artifacts, etc., can occur.

According to an exemplary embodiment, the DCC part 1600 includes an LUT that stores correction data to improve a liquid crystal response time. DCC part 1600 includes red, green and blue LUTs that respectively store red, green and blue correction data that respectively correspond to red, green and blue image data.

According to an exemplary embodiment, the DCC LUT stores correction image data that corresponds to image data of a current frame and a previous frame. Thus, DCC part 1600 uses the DCC LUT to generate DCC correction image data that corresponds to current frame correction image data generated from the first ACC part 1300 and previous frame correction data generated from the second ACC part 1400.

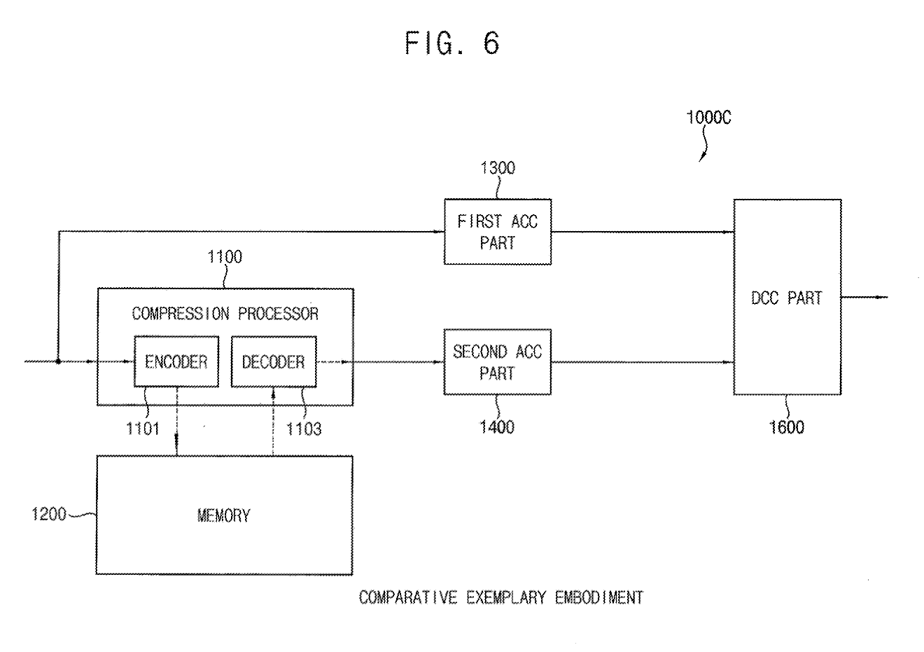

FIG. 6 is a block diagram of a correction data generator according to a comparative embodiment. Hereinafter, the same reference numerals are used to denote the same or similar parts as those described in previous exemplary embodiments, and the same detailed explanations are omitted unless necessary.

Referring to FIG. 6, a correction data generator 1000C according to a comparative exemplary embodiment omits the low-grayscale filter 1500 of the correction data generator 1000 according to an exemplary embodiment shown in FIG. 5.

According to a comparative embodiment, the second ACC part 1400 receives decompressed previous frame image data from the compression processor 1100 and corrects the decompressed previous frame image data.

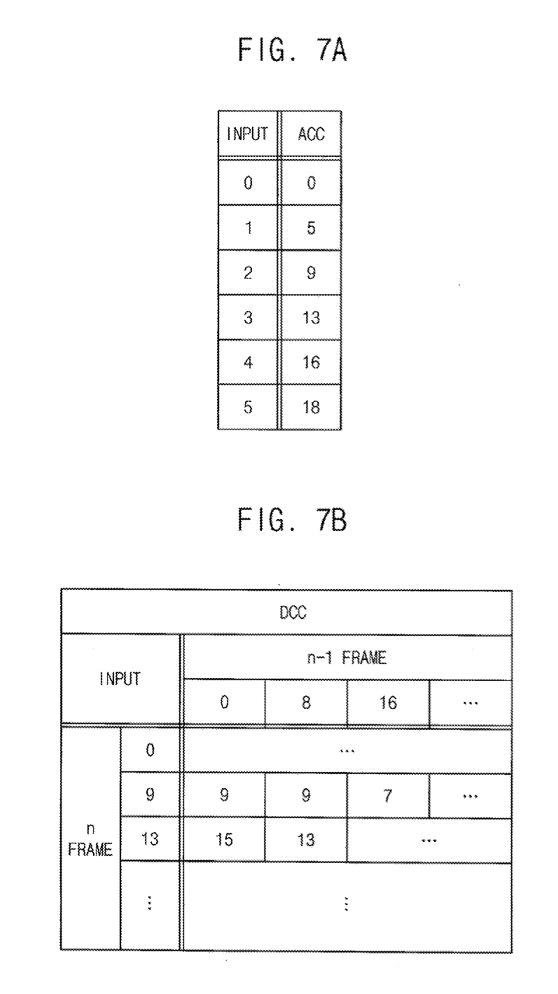

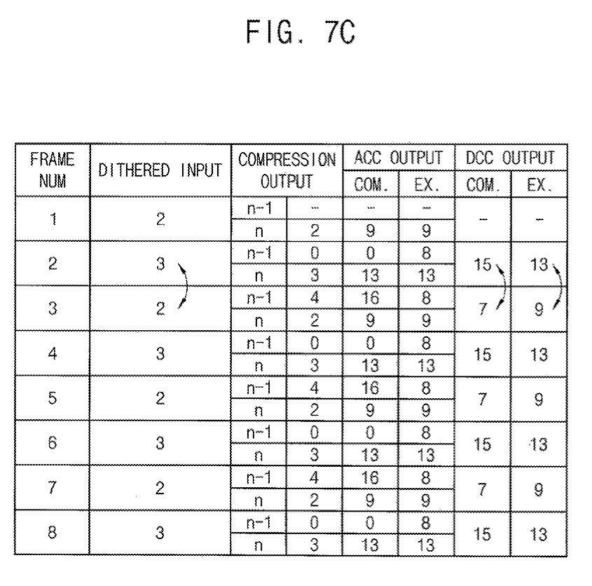

FIG. 7A is a table that illustrates an ACC LUT. FIG. 7B is a table that illustrates a DCC LUT. FIG. 7C is a table that illustrates a method of generating correction data according to an exemplary embodiment and a comparative exemplary embodiment.

For example, according to an exemplary embodiment, dithered pixel image data changes between 2-grayscale data and 3-grayscale data, the 2-grayscale data can be restored to 0-grayscale data by decompression and the 3-grayscale data can be restored to 4-grayscale data by decompression, and methods according to embodiments of correcting image data will be described below in greater detail.

Referring to FIGS. 5 and 7C, in an exemplary embodiment, the compression processor 1100 receives image data which changes between the 2-grayscale data and the 3-grayscale data. The compression processor 1100 restores the 2-grayscale data to the 0-grayscale data and the 3-grayscale data to the 4-grayscale data.

Referring to FIG. 7C, according to an exemplary embodiment, when the correction data generator 1000 receives 3-grayscale image data of a current second frame, the first ACC part 1300 uses the ACC LUT of FIG. 7A to generate 13-grayscale data as ACC correction data of the current second frame.

According to an exemplary embodiment, the compression processor 1100 compresses and decompresses 2-grayscale data of a previous first frame F1 and outputs 0-grayscale data as decompressed first frame F1 image data.

According to an exemplary embodiment, the second ACC part 1400 uses the ACC LUT shown in FIG. 7A to generate 0-grayscale data that corresponds to 0-grayscale data of the previous first frame F1 as ACC correction image data for the first frame F1.

According to art exemplary embodiment, the low-grayscale filter 1500 outputs image data with predetermined low-grayscale values when input image data grayscale values are less than or equal to a threshold low-grayscale value. For example, the threshold low-grayscale value is a 9-grayscale and the predetermined low-grayscale value is an 8-grayscale. When the input image data grayscale values are 0-grayscale to 9-grayscale, the low-grayscale filter 1500 outputs 8-grayscale image data.

Therefore, according to an exemplary embodiment, first frame F1 0-grayscale data, which is ACC correction image data generated from the second ACC part 1400 for the previous frame, is less than or equal to the 9-grayscale data of the threshold low-grayscale value. The low-grayscale filter 1500 outputs the predetermined 8-grayscale value as the ACC correction image data for the previous frame.

According to an exemplary embodiment, the DCC part 1600 uses the DCC LUT to generate DCC correction image data for the current frame that corresponds to current frame correction image data generated from the first ACC part 1300 and previous frame correction image data generated from the second ACC part 1400.

Referring to FIG. 7B, according to an exemplary embodiment, the DCC part 1600 uses the DCC LUT to generate 13-grayscale data that corresponds to 13-grayscale data of a current second frame F2 and 8-grayscale data for a previous first frame F1 as DCC correction image data for the current second frame F1.

Then, according to an exemplary embodiment, when the correction data generator 1000 receives 2-grayscale data of a third frame F3, the first ACC part 1300 generates 9-grayscale data using the ACC LUT shown in FIG. 7A as ACC correction image data for the current third frame F3.

According to an exemplary embodiment, the compression processor 1100 compresses and decompresses 3-grayscale data of a previous second frame F2 and outputs 4-grayscale data as restored image data of the second frame F2.

According to an exemplary embodiment, the second ACC part 1400 uses the ACC LUT shown in FIG. 7A to generate 16-grayscale data that corresponds to decompressed 4-grayscale data of the previous second frame F2 as ACC correction image data for the second frame F2.

Therefore, according to an exemplary embodiment, 4-grayscale ACC correction data of the previous second frame F2 generated by the second ACC part 1400 is less than or equal to the 9-grayscale threshold low-grayscale value. The low-grayscale filter 1500 outputs the predetermined 8-grayscale low-grayscale value as the previous frame's ACC correction image data.

According to an exemplary embodiment, the DCC part 1600 generates 9-grayscale data that corresponds to 9-grayscale data of the current third frame F3 and 8-grayscale data for the previous second frame F2 as DCC correction image data for the current third frame F3.

As described above, according to an exemplary embodiment, the correction data generator 1000 generates correction image data that changes between 13-grayscale data and 9-grayscale data with respect to input image data that changes between 2-grayscale data and 3-grayscale data.

However, according to a comparative exemplary embodiment, referring to FIGS. 6 and 7C, the compression processor 1100 receives image data which changes between 2-grayscale data and 3-grayscale data. The compression processor 1100 restores 2-grayscale data to 0-grayscale data and 3-grayscale data to 4-grayscale data.

According to an exemplary embodiment, when the correction data generator 1000 receives 3-grayscale data of the second frame F2, the first ACC part 1300 generates 13-grayscale data as ACC correction image data for the current second frame F2 using the ACC LUT shown in FIG. 7A.

According to an exemplary embodiment, the compression processor 1100 compresses and decompresses 2-grayscale data of a first frame F1 that precedes the second frame F2 and outputs 0-grayscale data as restored first frame F1 image data.

According to an exemplary embodiment, the second ACC part 1400 generates 0-grayscale data that corresponds to 0-grayscale data for the previous first frame F1 as ACC correction image data of the first frame F1 using the ACC LUT shown in FIG. 7A.

According to an exemplary embodiment, the DCC part 1600 uses the DCC LUT to generate DCC correction image data for the current frame that corresponds to ACC correction image data for the current frame and ACC correction image data for the previous frame. Referring to FIG. 7B, the DCC part 1600 uses the DCC LUT to generate 15-grayscale data that corresponds to 13-grayscale data of the current second frame F2 and 0-grayscale data of the previous first frame F1 as DCC correction image data of the current second frame F2.

Then, according to an exemplary embodiment, when the correction data generator 1000 receives 2-grayscale data of a third frame F3, the first ACC' part 1300 uses the ACC LUT shown in FIG. 7A to generate 9-grayscale data that corresponds to 2-grayscale data as ACC correction image data of the current third frame F3.

According to an exemplary embodiment, the compression processor 1100 compresses and decompresses 3-grayscale data of the second frame F2 that precedes the third frame F3 and outputs 4-grayscale data as restored image data of the second frame F2.

According to an exemplary embodiment, the second ACC part 1400 uses the ACC LUT shown in FIG. 7A to generate 16-grayscale data that corresponds to restored 4-grayscale data of the second frame F2 as ACC correction image data for the previous second frame F2.

According to an exemplary embodiment, the DCC part 1600 uses the DCC LUT to generate 7-grayscale data that corresponds to 9-grayscale data of the current third frame F3 and 16-grayscale of the previous second frame F2 as DCC correction image data for the current third frame F3.

As described above, according to a comparative exemplary embodiment, the correction data generator generates correction image data that changes between 15-grayscale data and 7-grayscale data with respect to input image data that changes between 2-grayscale data and 3-grayscale data.

Therefore, when input image data changes between 2-grayscale data and 3-grayscale data, correction image data according to a comparative exemplary embodiment changes between 15-grayscale data and 7-grayscale data and correction image data according to an exemplary embodiment changes between 13-grayscale data and 9-grayscale data. Thus, exemplary embodiments have about a 4-grayscale difference, less that about an 8-grayscale difference of a comparative exemplary embodiment.

According to an exemplary embodiment, grayscale data that is changed by compression and decompression processes can be transformed into predetermined low-grayscale data. Therefore, low-grayscale image display defects, such as flicker or other artifacts, etc., can be decreased.

Hereinafter, the same reference numerals are used to refer to the same or similar parts as those described in previous exemplary embodiments, and the same detailed explanations are omitted unless necessary.

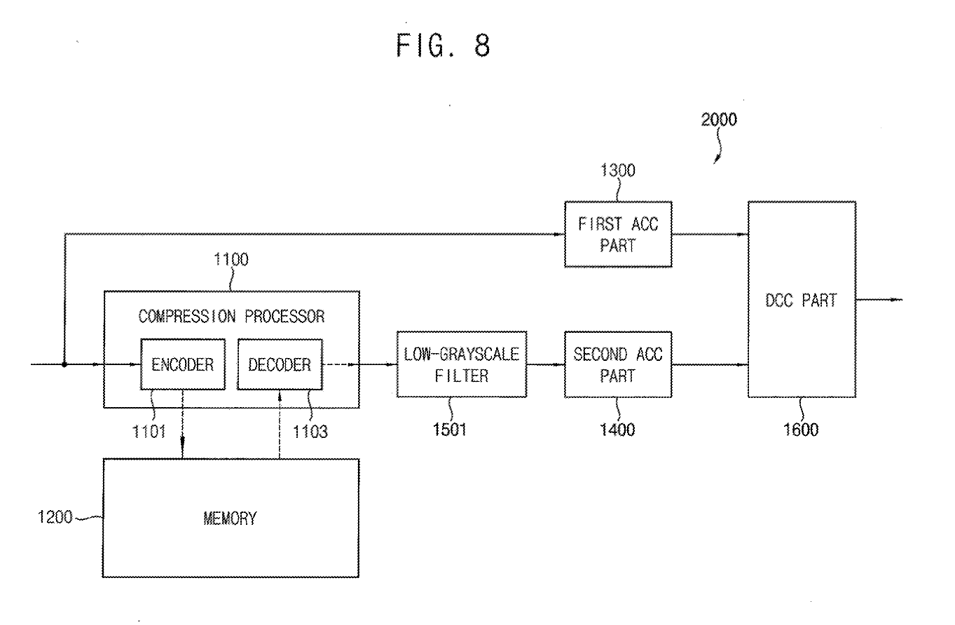

FIG. 8 is a block diagram of a timing controller according to an exemplary embodiment.

Referring to FIG. 8, according to an exemplary embodiment, the correction data generator 2000 includes a compression processor 1100, a memory 1200, a first ACC part 1300, a second ACC part 1400, a low-grayscale filter 1501 and a DCC part 1600.

According to an exemplary embodiment, the low-grayscale filter 1501 is disposed between an output portion of the compression processor 1100 and an input portion of the second ACC part 1400.

According to an exemplary embodiment, the low-grayscale filter 1501 transforms grayscale values of compressed and decompressed image data received from the compression processor 1100 into a predetermined low-grayscale values when the grayscale values of compressed and decompressed image data are less than or equal to a threshold low-grayscale value.

According to an exemplary embodiment, the low-grayscale filter 1501 is disposed at an input portion of the second ACC part 1400. Thus, decompressed data received from the compression processor 1100 that is less than or equal to the threshold low-grayscale value is transformed into predetermined low-grayscale data.

According to an exemplary embodiment, grayscale data that is changed by compression and decompression processes is transformed into predetermined low-grayscale data. Therefore, low-grayscale image display defects, such as flicker or other artifacts, etc., can be decreased.

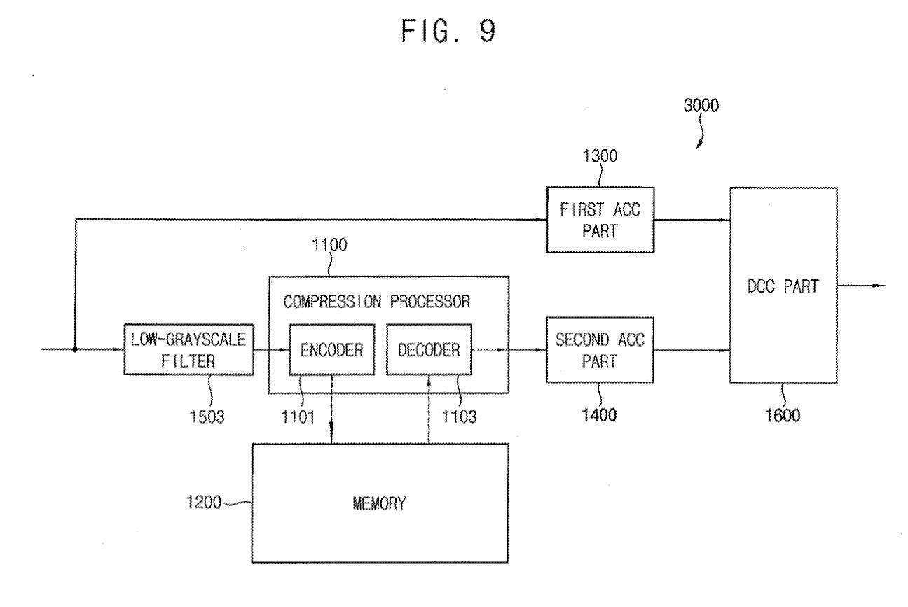

FIG. 9 is a block diagram of a timing controller according to an exemplary embodiment.

Referring to FIG. 9, according to an exemplary embodiment, the correction data generator 2000 includes a compression processor 1100, a memory 1200, a first ACC part 1300, a second ACC part 1400, a low-grayscale filter 1503 and a DCC part 1600.

According to an exemplary embodiment, the low-grayscale filter 1503 outputs image data of a predetermined low-grayscale value when grayscale values of dithered image data or shifted image data received from an external processor are less than or equal to a threshold low-grayscale value.

According to an exemplary embodiment, the low-grayscale filter 1503 is disposed at an input portion of the compression processor 1100. Thus, low-grayscale dithered or shifted image data received from an external processor data that is less than or equal to the threshold low-grayscale value is transformed into predetermined low-grayscale data. Thus, input image data to the compression processor 1100 is simplified which can decrease variability in the image data due to the compression processor.

According to an exemplary embodiment, grayscale data changed by compression and decompression processes can be transformed into predetermined low-grayscale data. Therefore, low-grayscale image display defects, such as flicker or other artifacts, etc., can be decreased.

According to exemplary embodiments, a low-grayscale filter is disposed between all processors that process image data of a previous frame in front of the DCC part and thus grayscale differences of the correction data due to image data variations that result from the compression processor can be decreased. Therefore, low-grayscale image display defects, such as flicker or other artifacts, etc., can be decreased.

Embodiments of the present inventive concept can be incorporated into a display device and an electronic device that has a display device. For example, embodiments of the present inventive concept can be incorporated into a computer monitor, a laptop, a digital camera, a cellular phone, a smart phone, a smart pad, a television, a personal digital assistant (PDA), a portable multimedia player (PMP), a MP3 player, a navigation system, a game console, a video phone, etc.

The foregoing is illustrative of embodiments of the inventive concept and is not to be construed as limiting thereof. Although a few exemplary embodiments of the inventive concept have been described, those skilled in the art will readily appreciate that many modifications are possible in the exemplary embodiments without materially departing from the novel teachings and advantages of the inventive concept. Therefore, it is to be understood that the foregoing is illustrative of the inventive concept and is not to be construed as limited to the specific exemplary embodiments disclosed, and that modifications to the disclosed exemplary embodiments, as well as other exemplary embodiments, are intended to be included within the scope of the appended claims. Embodiments of the inventive concept are defined by the following claims, with equivalents of the claims to be included therein.

1. A method of driving a display apparatus comprising:
correcting image data using a look-up table (LUT) that stores correction data, wherein grayscale differences between low-grayscale correction data and low-grayscale image data are greater than grayscale differences between middle-grayscale correction data and middle-grayscale image data;
transforming grayscale values of low-grayscale image data into predetermined low-grayscale values when grayscale values of the low-grayscale image data are less than or equal to a threshold low-grayscale value; and
correcting low-grayscale image data of a current frame using predetermined low-grayscale values of a previous frame.

2. The method of claim 1 further comprising:
correcting low-grayscale image data of the current frame using the LUT;
compressing and decompressing low-grayscale image data of the previous frame;
correcting decompressed low-grayscale image data of the previous frame using the LUT; and
transforming grayscale values of low-grayscale collection data of the previous frame into the predetermined low-grayscale values when the grayscale values of the low-grayscale correction data are less than or equal to the threshold low-grayscale value.

3. The method of claim 1, further comprising:
correcting low-grayscale image data of the current frame using the LUT;
compressing and decompressing low-grayscale image data of the previous frame;
transforming grayscale values of decompressed low-grayscale data of the previous frame into the predetermined low-grayscale values when grayscale values of the decompressed low-grayscale data are less than or equal to the threshold low-grayscale value; and
correcting the predetermined low-grayscale data of the previous frame using the LUT.

4. The method of claim 1, further comprising:
correcting low-grayscale image data of the current frame using the LUT;
transforming grayscale values of low-grayscale image data of the previous frame into predetermined low-grayscale values when the grayscale values of the low-grayscale image data of the previous frame are less than or equal to the threshold low-grayscale value;
compressing and decompressing the predetermined low-grayscale values of the previous frame; and
correcting the decompressed predetermined low-grayscale values of the previous frame using the LUT.

5. The method of claim 1, wherein the predetermined low-grayscale values are less than or equal to the threshold low-grayscale value.

6. A display apparatus comprising:
a compression processor that compresses image data using a memory;
a first compensation part that corrects image data using a look-up table (LUT) that stores correction data corresponding to the image data, wherein grayscale differences between low-grayscale correction data and low-grayscale image data are greater than grayscale differences between middle-grayscale correction data and middle-grayscale image data;
a low-grayscale filter that transforms grayscale values of low-grayscale image data into predetermined low-grayscale values when grayscale values of the low-grayscale image data are less than or equal to a threshold low-grayscale value; and
a second compensation part that corrects low grayscale image data of a current frame using predetermined low-grayscale values of a previous frame.

7. The display apparatus of claim 6, wherein the first compensation part comprises a first compensator that corrects data of the current frame using the LUT, and a second compensator that corrects data of the previous frame using the LUT.

8. The display apparatus of claim 7, wherein the compression processor compresses and decompresses low-grayscale image data of the previous frame,
the second compensator corrects decompressed low-grayscale image data of the previous frame using the LUT, and
the low-grayscale filter transforms grayscale values of the low-grayscale correction data of the previous frame into predetermined low-grayscale values when the grayscale values of the low-grayscale correction data are less than or equal to the threshold low-grayscale value.

9. The display apparatus of claim 7, wherein the compression processor compresses and decompresses low-grayscale image data of the previous frame,
the low-grayscale filter transforms grayscale values of decompressed low-grayscale image data of the previous frame into predetermined low-grayscale values when grayscale values of the decompressed low-grayscale image data are less than or equal to the threshold low-grayscale value, and
the second compensator corrects the predetermined low-grayscale values of the previous frame using the LUT.

10. The display apparatus of claim 7, wherein the low-grayscale filter transforms grayscale values of low-grayscale image data of the previous frame into predetermined low-grayscale values when grayscale values of the low-grayscale image data of the previous frame are less than or equal to the threshold low-grayscale value,
the compression processor compresses and decompresses the predetermined low-grayscale values of the previous frame; and
the second compensator corrects decompressed predetermined low-grayscale values of the previous frame using the LUT.

11. The display apparatus of claim 7, wherein the predetermined low-grayscale values are less than or equal to the threshold low-grayscale value.

12. The display apparatus of claim 7, further comprising:
a display panel that includes a plurality of pixels that are connected to a plurality of data lines and a plurality of gate lines;
a data driver that generates data voltages using correction data received from the second compensation part and provides the data voltages to the plurality of data lines; and
a gate driver that provides a plurality of gate signals to the plurality of gate lines.

13. A display apparatus comprising:
a first compensation part that corrects image data using a look-up table (LUT) that stores correction data, wherein the first compensation part includes a first compensator that corrects data of a current frame using the LUT, and a second compensator that corrects data of a previous frame using the LUT, wherein grayscale differences between low-grayscale correction data and low-grayscale image data are greater than a grayscale difference between middle-grayscale correction data and middle-grayscale image data;
a low-grayscale filter that transforms grayscale values of low-grayscale image data into predetermined low-grayscale values when grayscale values of the low-grayscale image data are less than or equal to a threshold low-grayscale value; and
a second compensation part that corrects low-grayscale image data of the current frame using predetermined low-grayscale values of the previous frame.

14. The display apparatus of claim 13, further comprising a compression processor that compresses and decompresses low-grayscale data of the previous frame, wherein
the second compensator corrects decompressed low-grayscale data of the previous frame using the LUT, and
the low-grayscale filter transforms grayscale values of the low-grayscale correction data of the previous frame into predetermined low-grayscale values when the grayscale values of the low-grayscale correction data are less than or equal to the threshold low-grayscale value.

15. The display apparatus of claim 13, further comprising a compression processor that compresses and decompresses low-grayscale data of the previous frame, wherein
the low-grayscale filter transforms grayscale values of decompressed low-grayscale data of the previous frame into predetermined low-grayscale values when grayscale values of the decompressed low-grayscale data are less than or equal to the threshold low-grayscale value, and
the second compensator corrects the predetermined low-grayscale values of the previous frame using the LUT.

16. The display apparatus of claim 13, further comprising a compression processor that compresses and decompresses image data using a memory,
wherein the low-grayscale filter transforms grayscale values of low-grayscale data of the previous frame into a predetermined low-grayscale value when grayscale values of the low-grayscale data of the previous are less than or equal to the threshold low-grayscale value,
the compression processor compresses and decompresses predetermined low-grayscale values of the previous frame; and
the second compensator corrects decompressed predetermined low-grayscale values of the previous frame using the LUT.

17. The display apparatus of claim 13, wherein the predetermined low-grayscale values are less than or equal to the threshold low-grayscale value.

18. The display apparatus of claim 13, further comprising:
a display panel that includes a plurality of pixels that are connected to a plurality of data lines and a plurality of gate lines;
a data driver that generates data voltages using correction data received from the second compensation part and provides the data voltages to the plurality of data lines; and
a gate driver that provides a plurality of gate signals to the plurality of gate lines.
